(19) United States
(12) Patent Application Publication
(10) Pub. No.: US 2012/0229383 A1
(43) Pub. Date: Sep. 13, 2012

(54) GESTURE SUPPORT FOR CONTROLLING AND/OR OPERATING A MEDICAL DEVICE

(76) Inventors: Christoffer Hamilton, Gronsdorf (DE); Nils Frielinghaus, Heimstetten (DE); Wolfgang Steinle, Munich (DE)

(21) Appl. No.: 13/512,605

(22) PCT Filed: Jan. 14, 2010
(86) PCT No.: PCT/EP2010/050404

§ 371 Date: May 30, 2012

(51) Int. Cl. G06F 3/033; G06F 3/01

(52) U.S. Cl. 345/158; 345/156

(57) ABSTRACT

The invention relates to a gesture support device (10) for controlling and/or operating a medical device (24), wherein the gesture support device is used to make gestures which are to be detected by a gesture detection system (23) and translated into control and/or operating inputs for the medical device (24), characterized in that the gesture support device (10) comprises discrete or delimited sections (12-18) which can be recognized as such by the gesture detection system (23). It also relates to a system for controlling and/or operating a medical device (24), comprising such a gesture support device, and to a method for controlling and/or operating a medical device (24).

The present invention relates to the technical field of controlling and/or operating a medical device. In particular, the invention relates to controlling and/or operating a medical device by means of gestures which are detected by a gesture detection system and translated into control and/or operating inputs for a medical device.

Operating and/or controlling medical devices, for example in operating theaters, is often cumbersome or problematic for physicians in terms of allowing for intuitive control or maintaining high levels of stability. Touch screens, keyboards and mouses, voice control or remote controls have for example been used as different modes of interaction between a user and a medical device such as a medical navigation system. While touch screens allow for intuitive control and/or operation, it is necessary to maintain their sterility by draping them with sterile drapes or by using sterile touching devices such as sterile pens. Another problem with touch screens is that they must be approached in order to be used, such that the user is required to leave their working position. Conversely, keyboards and mouses, voice control systems or remote controls do not intuitive control and may also be difficult to sterilize.

U.S. Pat. No. 6,002,808 discloses a hand gesture control system for the control of computer graphics, in which image moment calculations are utilized to determine an overall equivalent rectangle corresponding to hand position, orientation and size.

It is the object of the present invention to provide a device, a system and a method for controlling and/or operating a medical device, which improve on the existing solutions as described above. In particular, at least one of the problems of lack of sterility, lack of intuitive control and lack of precisely definable commands/inputs is to be solved by the present invention.

This object is achieved by a gesture support device in accordance with claim 1, a system for controlling and/or operating a medical device in accordance with claim 12 and a method of controlling and/or operating a medical device in accordance with claim 13. The sub-claims define advantageous embodiments of the present invention.

In accordance with one aspect of the invention, a gesture support device for controlling and/or operating a medical device is provided. The gesture support device is used to make gestures which are to be detected by a gesture detection system and translated into control and/or operating inputs for the medical device. The gesture support device comprises discrete or delimited sections which can be recognized as such by the gesture detection system. The system in accordance with the present invention comprises such a gesture support device and at least a gesture detection system and may also comprise a gesture translation system and a medical device to be controlled and/or operated. In accordance with the method of the present invention, gestures are made by means of a gesture support device as defined above.

In other words, the present invention offers an improved way of controlling and/or operating a medical device by choosing gestures as the means of control and/or operation and designing the gesture inputs in such a way that gestures can be easily and reliably identified by the gesture detection system and can be made in a mutually distinctive manner by means of an easy-to-manage gesture support device (gesture generating means). By making different sections of the gesture support device visible or invisible to the gesture detection system, the user can generate different control and/or operating inputs which can then result in different actions being taken by the medical device. Using discrete or delimited sections on the gesture support device, it is easy to hide or expose one or more of said sections in order to create a recognizable input.

One of the advantages of the present invention is that the user does not need to learn a multitude of unnatural gestures in order to be able to create a variety of commands. Rather, this variety is created by the sectional structure of the gesture support device, i.e. by the possibility of associating a number of respective commands with a number of combinations of shown or hidden sections. The gesture support device merely needs to be held by the user in a predetermined way and pointed, which is a natural and intuitive movement. The failure rate will be very low, since important actions can be assigned to “images”, i.e. combinations of shown and/or hidden sections, which can be easily created using the gesture support device. Moreover, a gesture support device comprising discrete or delimited sections which can be recognized by a gesture detection system is generally a very simple device which can be easily and inexpensively manufactured and, if provided with a simple structure and a suitable outer form and/or material, can be easily sterilized.

In accordance with one embodiment of the invention, the entire gesture support device can be divided into discrete sections which can be recognized as such by the gesture detection system.

The discrete or delimited sections mentioned above can be designed in such a way that they comprise recognizable elements or structures. In particular, said sections can exhibit certain patterns or can be colored in a distinctive way. Alternatively, they can be differentiated by their size or by a certain labeling. Any combinations of these features are also possible.

In one embodiment of the present invention, the gesture support device consists of several parts which have to be assembled in order to form the complete or functional gesture support device, each part comprising one or more discrete or delimited sections. It is then possible to provide the parts with a connection system which allows them to be connected in one or more predetermined and distinguishable relative positions. In other words, the sections of the gesture support device, which is for example formed as a sort of “wand”, can be provided separately and then assembled in situ in different configurations, and a user can personalize the arrangement of the sections in order to create and configure a certain command structure. In an extension of this idea, the sections can be designed to be independently rotatable, such that different commands can be configured, selected or issued by rotating sections or segments into different positions.

The gesture support device can also be a foldable device which can in particular be folded along the borders between sections. It is thus possible to adapt the recognition system in such a way that an unfolded gesture support device is recognized as an active device while a folded gesture support device is recognized as an inactive device. An active or inactive state of the device can also be indicated in other ways which will be described below.

In accordance with the present invention, the gesture support device can comprise a designated sterile area and a designated non-sterile area and can in particular comprise a sterile border portion or border element in between. Such a configuration would for example allow the user to use a tip portion of the sterile area of the gesture support device as a touch pointer, for example for a touch screen.

It is possible to provide the gesture support with a designated, in particular marked or labeled, grip portion. Fitting the gesture support device with such a grip ensures that the sections are correctly oriented in relation to a user, i.e. for example that the correct portion or end of the gesture support device is pointed towards the gesture recognizing device or gesture detection system. In another implementation, hand recognition—in particular on the grip portion but also in general—can be used to determine where the user is holding the gesture support device, in order to adapt the interpretation of gestures or the arrangement of the sections accordingly.

In one embodiment of the present invention, the gesture support device can comprise a control button, in particular an activating button for issuing control outputs electronically or as audio outputs. Such a button can be associated with a wireless signal sending device (for issuing control outputs electronically) or can have a very simple design, for example simply including a clicking device for issuing audible signals.

The gesture support device of the present invention can assume various forms, including a rod-like form, a cube-shaped form or a spherical form. A rod-like form would have the advantage of better supporting pointing gestures, while cube-shaped or spherical forms could provide comparatively larger sectional areas which could aid in identifying (recognizing) the sections.

The advantages and embodiments of rod-like gesture support devices will now be discussed below with reference to particular embodiments. The advantages of cube-shaped or spherical gesture support devices, or gesture support devices which have cube-shaped or spherical portions, include the possibility of one side comprising a section which is intended to face the gesture recognition system and an opposite side being directed towards the user. A label could then for example be provided on the side facing the user which could inform the user about the command being shown on the other side (facing the gesture detection system). Thus, the user can be very easily informed as to which section(s) is/are currently being shown to the gesture recognition system and therefore which command is being given at that point in time.

In accordance with a preferred embodiment of the present invention, the medical device is an image-guided medical or surgical system, in particular a medical navigation system. The gestures would then for example be used to select certain points or areas on imaged patient data or to select functions of the navigational assistance program.

In the method of the present invention, the gestures can be generated by means of gesture support devices which can be hand-held and/or manually manipulated. Control and/or operating inputs can be identified on the basis of the pointing direction of the gesture support device, the rotational position or direction of the gesture support device or one or more of its sections and/or the position and/or orientation of the hand on the gesture support device, and in particular on the basis of whether sections of the support device are covered or visible when the gesture support device is handled or gripped by a user.

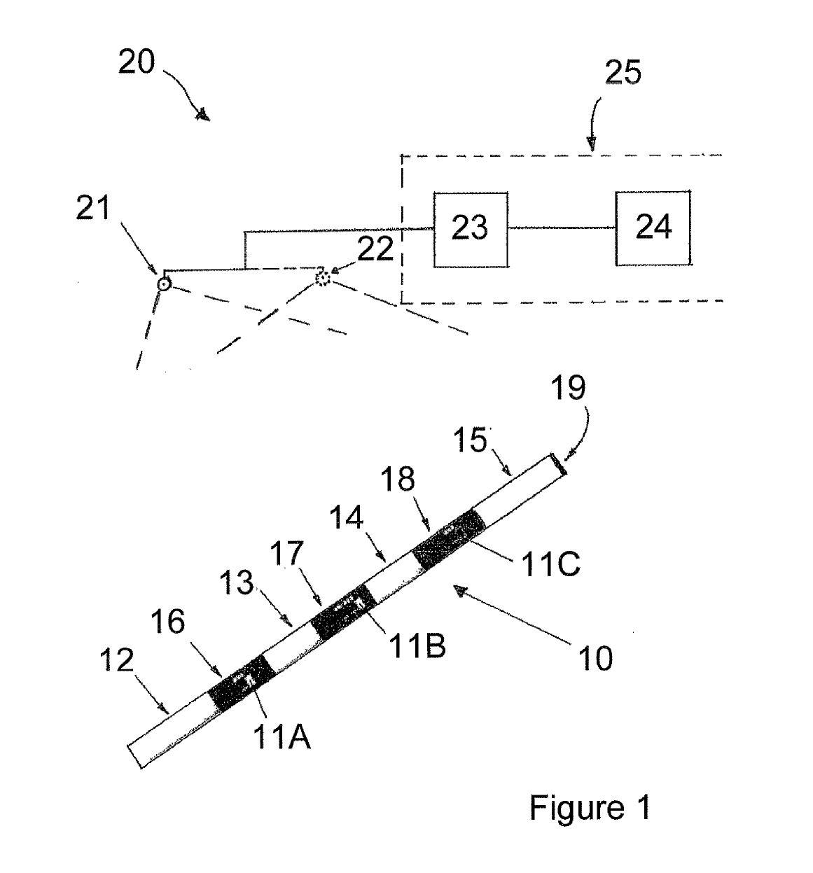

The invention will now be explained in greater detail by referring to specific embodiments. It should be noted that each of the features of the present invention as referred to herein can be implemented separately or in any expedient combination. In the attached drawing, FIG. 1 depicts an embodiment of a gesture support device in accordance with the invention, and a schematic representation of a gesture detection system and a medical device which is to be controlled and/or operated.

The gesture support device shown in FIG. 1 is embodied as a rod and has been given the reference numeral 10 as a whole. It comprises a number of discrete sections 12 to 18 which are delimited from each other—in the present case, four white or uncolored sections 12 to 15 and three sections 16, 17 and 18 which exhibit a darker color and have recognition patterns 11A, 11B and 11C placed on them. The patterns 11A, 11B and 11C can be permanently attached to the rod 10 or provided as removable adhesive labels. This also applies to any of the sections 12 to 18. The sections can also exhibit different lengths—in the embodiment of FIG. 1, sections 12 and 15 are slightly longer than sections 13, 14, 16, 17 and 18.

The tip of the rod 10 has a special tip marking 19 which can exhibit a particular color or pattern (not shown) or comprise a particular material on its end face.

The gesture recognition device is shown schematically in FIG. 1 and has been given the reference numeral 20 as a whole. Strictly speaking, the gesture recognition device can merely include a camera system comprising one or two cameras 21, 22, and a graphic processing unit 23 connected to the camera system. The camera system has at least one camera, but a system with two cameras 21, 22 can be provided, in particular if three-dimensional positions or gestures are to be recognized. The camera system can be a video camera system or also an infrared optical tracking system which is usually employed in conjunction with medical or surgical navigation. It should be noted in general that the gesture support device, for example the rod 10, should be designed in accordance with the functional setup of the detection system, i.e. such that at least some of the sections or portions of the support device can be recognized and distinguished by a video camera system and/or infrared detection (camera) system, for example by choosing suitable materials or labels, colors, patterns, etc.

As mentioned above, the gesture recognition system also comprises the graphic processing unit 23 which translates the gestures captured by the camera 21 (or cameras 21 and 22) into control and/or operating inputs for a medical device—in the present case, a schematically shown medical navigation system 24. As mentioned above, the gestures can then for example be used to select and/or activate navigational assistance functions of the navigation system 24. An instrument tracking system can for example be used and/or operated in order to show, on a display, the positional relationship between instruments and a patient's body, images of which have been acquired beforehand, for example as CT or MR image data sets. The navigation system 24 can also be used to guide a user through a sequence of steps to be carried out during a medical procedure, and the present invention can also provide control and/or operating inputs to this end.

The graphic processing unit 23 and the navigation system 24 have been enclosed with a dashed line, which is intended to indicate that the graphic processing unit 23 and the navigation system 24 can be integrated in one system. In some cases, the computer system of the medical navigation system will perform both functions, i.e. graphic processing will also be performed by an integrated navigation system 25.

The rod 10 is a device which can be hand-held and/or manually manipulated. Depending on where the user places their hand, one or more of the sections 12 to 18 will be covered, and the remaining section or combination of sections will communicate a certain command or operational input which can be recognized by the gesture detection system, i.e. depending on the placement of the hand, different actions can be selected for execution by the medical device—for example, a zoom command can be issued. One option would be to show the placement of the hand to the gesture recognition device, such that the command can be identified. When the user then points the tip of the wand towards a predetermined or trackable location, for example towards the gesture detection system, a camera or a certain location on the navigation system display, the actual command will be given, i.e. the action will be performed (for example, a zooming action initiated by moving the wand to the left or right or by choosing a certain element shown on the screen). Labeling the rod at different sections thus enables gesture recognition to be performed quickly by covering or uncovering different sections of the gesture support device 10.

In one embodiment, gesture detection is only active when the gesture support device or rod 10 is pointed directly towards the gesture detection system or towards a certain, predetermined location. The tip of the wand can be used to provide an additional variety of communication signals. For example, the tip 19 can be temporarily covered by the user's finger, which can be interpreted by the gesture detection system as a selection command comparable to a mouse click. In order to support this feature, the tip 19 can be provided with a signaling color (for video cameras) or covered with a material which is visible in the infrared range, such that it can be used with normal cameras and/or infrared cameras. Specific commands could also be assigned to covering the tip of the rod, for example with the index finger, completely or at a particular location or at a predetermined time. Covering the tip in this way could also be interpreted so as to activate a subsequent action, again in the manner of one or more mouse clicks.

Other possible uses include rotating the rod in order to initiate a rotating action, for example in order to initiate the rotation of a three-dimensional patient image on the navigation display.

Another embodiment relates to using the rod-like structure of the gesture support device 10 in a particular way in combination with another device. The rod could for example be used as a joystick in order to control a medical device, in particular parameters of the device such as its orientation, height, brightness, contrast, etc., when inserting the rod into a base connected to a computer device.

1. A gesture support device for controlling and/or operating a medical device, wherein the gesture support device is used to make gestures which are to be detected by a gesture detection system and translated into control and/or operating inputs for the medical device, characterized in that the gesture support device comprises discrete or delimited sections which can be recognized as such by the gesture detection system.

2. The gesture support device according to claim 1, characterized in that it is divided into discrete sections which can be recognized as such by the gesture detection system.

3. The gesture support device according to claim 1, characterized in that the sections comprise recognizable elements or structures, in particular one or more of the following:
patterns (11A, 11B, 11C);
sizes;
colors;
labels.

4. The gesture support device according to claim 1, characterized in that it consists of several parts which have to be assembled in order to form the functional gesture support device, each part comprising one or more of the discrete or delimited sections.

5. The gesture support device according to claim 4, characterized in that the parts comprise a connection system which allows them to be connected in one or more predetermined and distinguishable relative positions.

6. The gesture support device according to claim 1, characterized in that it is a foldable device which can in particular be folded along the borders between sections.

7. The gesture support device according to claim 1, characterized in that it comprises a designated sterile area and a designated non-sterile area and in particular comprises a sterile border portion or border element in between.

8. The gesture support device according to claim 1, characterized in that it comprises a designated, in particular marked or labeled, grip portion.

9. The gesture support device according to claim 1, characterized in that it comprises a control button, in particular an activating button for issuing control outputs electronically or as audio outputs.

10. The gesture support device according to claims 1, characterized in that it has a rod-like form, a cube-shaped form or a spherical form.

11. The gesture support device according to claims 1, characterized in that the medical device is an image-guided medical or surgical system, in particular a medical navigation system.

12. A system for controlling and/or operating a medical device, comprising a gesture support device according to claim 1 and a gesture detection system, and in particular:
a gesture translation system for translating detected gestures into control and/or operating inputs for the medical device; and/or
the medical device itself.

13. A method for controlling and/or operating a medical device, wherein gestures are detected by a gesture detection system and translated into control and/or operating inputs for the medical device, and wherein the gestures are generated by means of a gesture support device which can be hand-held and/or manually manipulated and which comprises discrete or delimited sections which can be recognized as such by the gesture detection system.

14. The method according to claim 13, wherein the control and/or operating inputs are identified on the basis of one or more of the following:
the pointing direction of the gesture support device;
the rotational position or direction of the gesture support device or one or more of its sections; and/or
the position and/or orientation of the hand on the gesture support device, in particular whether sections of the support device are covered or visible when the gesture support device is handled or gripped by a user.
